(19) United States
(12) Patent Application Publication
(10) Pub. No.: US 2010/0332666 A1
(43) Pub. Date: Dec. 30, 2010

(54) COMMUNICATION APPARATUS PERFORMING COMMUNICATION PARAMETER CONFIGURATION PROCESS AND METHOD FOR CONTROLLING THE SAME

(75) Inventor: Toshifumi Hamachi, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/666,180

(22) PCT Filed: Aug. 28, 2008
(86) PCT No.: PCT/JP2008/065917

§ 371 Date: Dec. 22, 2009

(30) Foreign Application Priority Data
Sep. 5, 2007 (JP) 2007-230408

(51) Int. Cl. G06F 15/16

(52) U.S. Cl. 709/228

(57) ABSTRACT

The present invention solves a problem that can occur when operation for performing a communication parameter configuration process is started on three or more communication apparatuses. For that purpose, when a communication apparatus that is performing a communication parameter configuration process with a first communication apparatus receives a start request to start a communication parameter configuration process from a second communication apparatus, the communication apparatus sends, to the second communication apparatus, network information in which the communication apparatus participates after the end of the communication parameter configuration process with the first communication apparatus.

### TECHNICAL FIELD

The present invention relates to a communication apparatus that performs a communication parameter configuration process and a method for controlling the communication apparatus.

### BACKGROUND ART

To use a wireless LAN conforming to IEEE 802.11 (hereinafter referred to as a wireless LAN), a user must configure wireless communication parameters such as a network identifier (ESSID), frequency channel, encryption method, encryption key, authentication method, and authentication key. Because configuring these parameters is complicated, methods have been proposed for automatically configuring wireless parameters between apparatuses. For example, a method for transferring a wireless parameter configuration used between an access point (relay center) and a station (terminal station) from the access point to the station with a simple operation has been implemented as a commercially available product.

A group called Wi-Fi Alliance has recently developed WPS (Wi-Fi Protected Setup), which is a specification for automatically configuring wireless parameters and has already been integrated in a number of products.

In WPS, a special protocol (called Registration Protocol) for the process of configuring wireless communication parameters is used to provide wireless parameters from a registrar to an enrollee. A registrar is an apparatus that manages wireless parameters and provides wireless parameters to an enrollee. An enrollee is an apparatus that receives wireless parameters provided from a registrar.

In the Registration Protocol, communication between a registrar and an enrollee is performed using EAP (Extensible Authentication Protocol) packets. EAP packets are packets that can be transmitted between a registrar and an enrollee without performing encryption and authentication.

An example will be described in which wireless parameters are provided from an access point acting as a registrar to a station acting as an enrollee. First, the station searches for a network formed by the access point and temporarily joins the network. At this point in time, the ESSID and the frequency channel of the station match those of the access point but parameters such as the encryption key and authentication key do not. Therefore data communication using encryption and authentication cannot be performed.

The access point exchanges messages with the station using EAP packets according to the Registration Protocol to provide wireless parameters to the station. The station, which acts as an enrollee, configures the new wireless parameters provided. This configuration enables data communication between the access point and the station using encryption and authentication.

WPS specifies a method for configuring wireless parameters in infrastructure mode of a wireless LAN but does not specify a configuration method in ad-hoc mode. The infrastructure mode is a mode in which wireless communication is performed between stations through an access point and the ad-hoc mode is a mode in which stations directly communicate with each other without using an access point.

Opportunities of doing wireless communication in ad-hoc mode are increasing, such as communications between digital cameras and between game machines that include wireless LAN facilities. WPS will likely be applied to ad-hoc mode in the future. A number of simple methods for configuring wireless parameters in ad-hoc mode have been proposed (US 2002/0147819 (Japanese Patent Laid-Open No. 2002-359623) and US 2006/0246947 (Japanese Patent Laid-Open No. 2006-311138)).

The Registration Protocol in WPS is designed to be executed between two apparatuses and cannot be executed among three or more apparatuses at a time.

On the other hand, when a multiplayer game is played using game machines, situations can be conceived of in which more than two apparatuses perform wireless communication at a time. Therefore, when WPS is to be applied to ad-hoc mode, a control algorithm capable of addressing the situations where WPS is activated on more than two apparatuses at a time is required to be integrated in the apparatuses.

For example, suppose three apparatuses A, B, and C form a network for configuring wireless parameters and apparatus A receives a Registration Protocol start request from apparatus C while apparatus A is executing the Registration Protocol with apparatus B. In this case, the Registration protocol is not started between apparatuses C and A. If the Registration Protocol is not started after a predetermined period of time elapsed since transmission of the registration start request, apparatus C may resends the start request.

However, apparatus C does not know when the Registration Protocol between apparatuses A and B will end. Therefore, when apparatus C resends the start request, the Registration Protocol between apparatuses A and B may not yet have ended. As a result, the wireless parameter configuration process using WPS on apparatus C can time out.

Furthermore, apparatuses A and B may have formed a new network using the configured wireless parameters after the Registration Protocol has ended. If this is the case, when apparatus C resends the registration protocol start request, apparatuses A and B have already left the wireless parameter configuration network and therefore do not receive the start request.

In such a case, to restart configuration of the wireless parameters on apparatus C, the user must instruct again apparatus C to activate WPS, which impairs usability for the user.

The problem can also arise with communication parameters for communication of other types such as wired communication that requires configuration for communication between apparatuses, as well as wireless parameters.

### DISCLOSURE OF INVENTION

According to the present invention, an appropriate process is performed when an operation for performing a communication parameter configuration process is initiated among three or more communication apparatuses.

One aspect of the present invention is a control method for controlling a communication apparatus that performs a communication parameter configuration process, comprising a step of performing a communication parameter configuration process between the communication apparatus and a first communication apparatus, a step of detecting a start request to start communication parameter configuration process sent from a second communication apparatus while the communication parameter configuration process is being performed between the communication apparatus and the first communication apparatus, and a step of sending, to the second communication apparatus, network information of a network in which the communication apparatus participates after the end of the communication parameter configuration process between the communication apparatus and the first communication apparatus, when the start request is detected in the detecting step.

Another aspect of the present invention is a control method for controlling a communication apparatus that performs a communication parameter configuration process, comprising a step of requesting another communication apparatus to start a communication parameter configuration process, a step of receiving a signal including network information in response to the request and determining a network over which the start of the communication parameter configuration process is notified from the another communication apparatus on the basis of the network information included in the signal received in the receiving step.

Further features of the present invention will become apparent from the following description of exemplary embodiments (with reference to the attached drawings).

### BRIEF DESCRIPTION OF DRAWINGS

FIG. 1 is a system configuration diagram;

FIG. 2 is a block diagram showing a configuration of a digital camera DSC1, DSC2, DSC3;

FIGS. 3A and 3B are flowcharts illustrating a process performed in a providing apparatus in a first embodiment;

FIG. 4 is a flowchart illustrating a process performed in a receiving apparatus in the first embodiment;

FIG. 5 is a sequence diagram of the first embodiment;

FIGS. 6A and 6B are flowcharts of a process performed in a providing apparatus in a second embodiment;

FIG. 7 is a flowchart of a process performed in a receiving apparatus in the second embodiment; and

FIG. 8 is a sequence diagram of the second embodiment.

### DESCRIPTION OF THE EMBODIMENTS

The best mode for carrying out the present invention will be described below in detail with reference to the accompanying drawings.

### First Embodiment

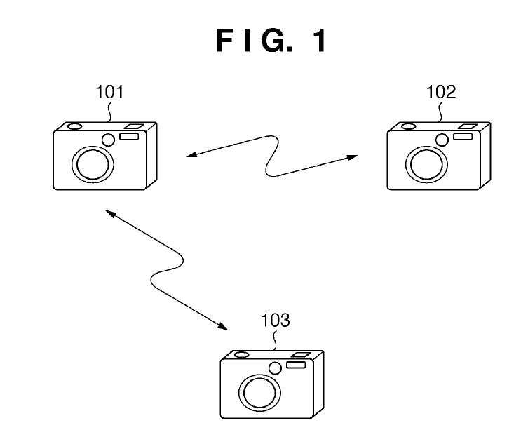

FIG. 1 shows a system configuration in a first embodiment of the present invention.

Digital cameras 101, 102, and 103 (hereinafter referred to as DSC1, DSC2, and DSC3, respectively) include wireless communication facilities of a wireless LAN conforming to IEEE 802.11 specification series (hereinafter referred to as a wireless LAN).

DSC1, DSC2, and DSC3 are capable of forming a wireless LAN in ad-hoc mode (ad-hoc network) and each of the cameras includes the same automatic wireless parameter configuration application. When the automatic wireless parameter configuration application is activated, the process of configuring wireless parameters can be performed on the ad-hoc network by using a configuration information notification protocol.

The configuration information notification protocol herein is a simplified representation of messages in the Registration Protocol. Accordingly, if an ESSID (network identifier) and a frequency channel match, messages can be sent and received using the configuration information notification protocol without encryption and authentication. The configuration information notification protocol is executed between two apparatuses on the same ad-hoc network but cannot be executed among more than three apparatuses at a time.

Wireless parameters that are configured by the configuration information notification protocol include an ESSID, frequency channel, encryption method, encryption key, authentication method, and authentication key. The network on which the wireless parameter configuration process is performed using the configuration information notification protocol may be the same network over which data communication is performed after the wireless parameters are configured or may be a different network.

DSC1, DSC2, and DSC3 include the function of assigning a role in the wireless parameter configuration process according to a predetermined algorithm (hereinafter referred to as the roll assignment algorithm) when the automatic wireless parameter configuration application is activated. Roles in the wireless parameter configuration process include a providing apparatus that provides wireless parameters by using the configuration information notification protocol and a receiving apparatus that receives the wireless parameters provided. It is assumed here that DSC1 is assigned as a providing apparatus and DSC2 and DSC3 are assigned as receiving apparatuses according to the role assignment algorithm.

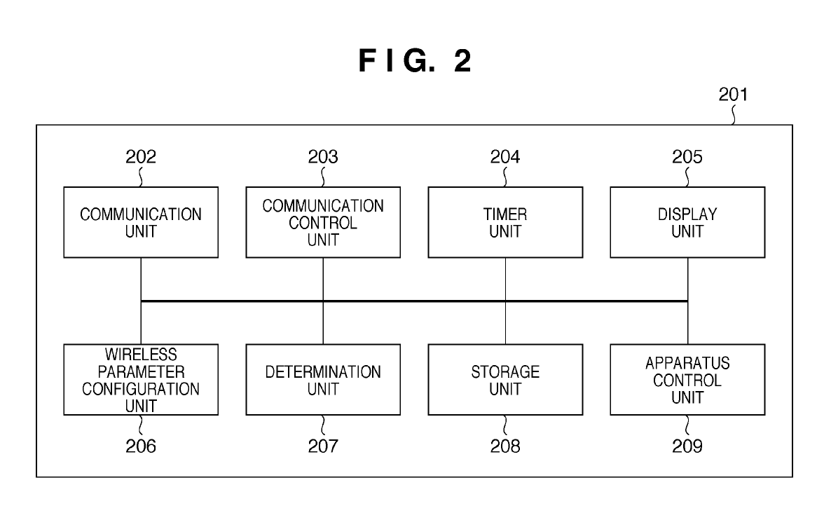

A configuration of DSC1, DSC2, and DSC3 will be described with reference to the block diagram in FIG. 2.

Reference numeral 201 denotes the whole apparatus. Reference numeral 202 denotes a communication unit that provides wireless communication and reference numeral 203 denotes a communication control unit that controls the communication unit. Reference numeral 204 denotes a timer unit that performs timer processing. Reference numeral 205 denotes a display unit that displays various kinds of information.

Reference numeral 206 denotes a wireless parameter configuration unit that performs a wireless parameter configuration process using the configuration information notification protocol. Messages such as a protocol start request, protocol start message, and protocol end message are sent and received under the control of the wireless parameter configuration unit 206.

Reference numeral 207 denotes a determination unit that performs various kinds of determination processes. Reference numeral 208 denotes a storage unit that stores data such as wireless parameters. Reference numeral 209 denotes an apparatus control unit that controls an operation of the entire apparatus.

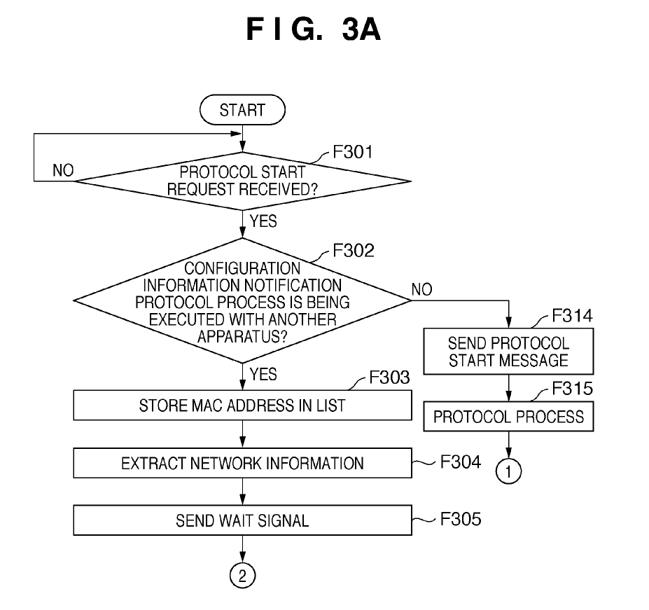

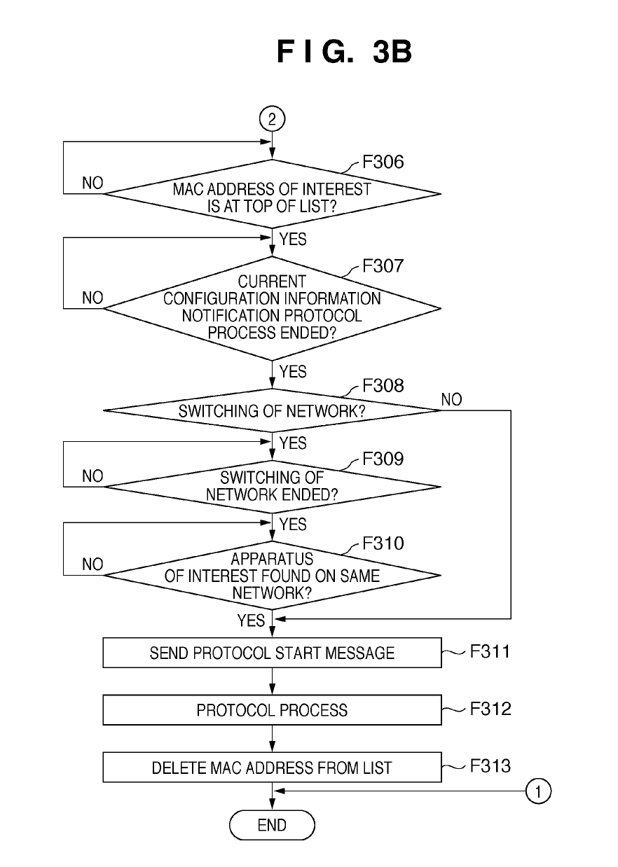

A process procedure performed by DSC1, which is the providing apparatus, will be described with reference to the flowcharts of FIGS. 3A and 3B. The process is started when the roll of providing apparatus in the wireless parameter configuration process is assigned to the apparatus according to the role assignment algorithm. The process is performed for each of the receiving apparatuses (DSC2 and DSC3).

DSC1 waits for a protocol start request sent from a receiving apparatus (F301). The protocol start request is a message used by a receiving apparatus for requesting the providing apparatus to start a configuration information notification protocol. It is assumed here that DSC2 sends a protocol start request first and then DSC3 sends a protocol start request.

Upon reception of the protocol start request from DSC2, DSC1 determines whether a configuration information notification protocol is being executed with another receiving apparatus (F302).

If the configuration information notification protocol is not being executed with another receiving apparatus, DSC1 sends a protocol start message to DSC2 (F314). Here, the protocol start message is a message sent by a providing apparatus to a receiving apparatus to notify the receiving apparatus of the start of a configuration information notification protocol.

After sending the protocol start message, DSC1 exchanges various messages with DSC2 using the configuration information notification protocol to provide wireless parameters to DSC2 (F315).

If the configuration information notification protocol is being executed with another receiving apparatus at F302 (in this example, when DSC1 receives a protocol start request from DSC3 while DSC1 is executing the configuration information notification protocol with DSC2), the process proceeds to F303. DSC1 stores the MAC (Media Access Control) address of DSC3, which has sent the protocol start request after DSC2, in the storage unit 208 (F303). Here, the MAC address is stored in a list in the storage unit 208 in a FIFO (First-In First-Out) manner.

DSC1 extracts network information (such as an ESSID and a frequency channel) of a network on which the configuration information notification protocol is to be executed with DSC3 (F304). That is, DSC1 extracts the ESSID and the frequency channel from among the wireless parameters to be provided to DSC2 using the configuration information notification protocol being executed.

For example, if the network on which the configuration information notification protocol is being executed with DSC2 (the network in which DSC1 is currently participating) differs from the network over which data communication is to be performed after the wireless parameters are configured, DSC1 extracts network information of the network over which the data communication is to be performed.

If the network on which the configuration information notification protocol is being executed with DSC2 (the network in which DSC1 is currently participating) is the same as the network over which data communication is to be performed after the wireless parameters are configured, DSC1 extracts network information of the network in which DSC1 is currently participating.

DSC1 sends a wait signal to which the extracted network information is added to DSC3 (F305) and waits until the MAC address of DSC3 moves to the top of the list in the storage unit 208 (F306).

When the MAC address of DSC3 appears at the top of the list in the storage unit 208, DSC1 determines whether the current configuration information notification protocol has ended (F307). If the current configuration information notification protocol has ended, DSC1 determines whether to make switching to another network (F308). Switching to another network will be made when the network on which the configuration information notification protocol has been executed with DSC2 (the network in which DSC1 is currently participating) differs from the network over which data communication is to be performed after the wireless parameters are configured. Switching to another network will not be made when the network on which the configuration information notification protocol has been executed with DSC2 (the network in which DSC1 is currently participating) is the network over which data communication is to be performed after the wireless parameters are configured.

If switching of the network is not to be made, DSC1 sends a protocol start message to DSC3 (F311).

If switching of the network is to be made, DSC1 waits until the communication control unit 203 completes the process for switching of the network (F309). After completion of the switching of the network, DSC1 waits until DSC3 is found on the new network (F310). DSC3 may be found by receiving an annunciation signal (beacon) or a prove request sent by DSC3. When DSC1 finds DSC3 on the new network, DSC1 sends a protocol start message to DSC3 (F311). Then, DSC1 exchanges various messages with DSC3 using the configuration information notification protocol to provide wireless parameters to DSC3 (F312). DSC1 then deletes the MAC address of DSC3 from the list in the storage unit 208 (F313). If the MAC address of a receiving apparatus to which wireless parameters have not yet been provided remains on the list, the process returns to F306 and the steps described above are repeated.

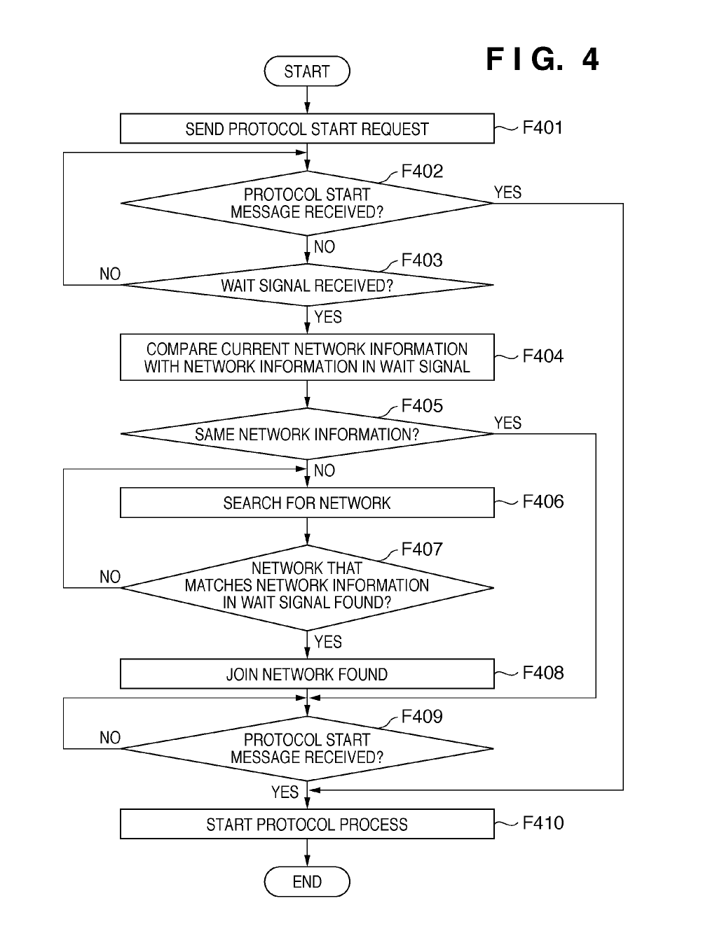

A process procedure performed by DSC2 and DSC3, which are receiving apparatuses, will be described with reference to the flowchart of FIG. 4. The process is started when the role of receiving apparatus in the wireless parameter configuration process is assigned by the role assignment algorithm described above. In some cases, the process may be started after a predetermined period of time has elapsed since the apparatus is assigned as a receiving apparatus.

The receiving apparatuses DSC2 and DSC3 send a protocol start request to DSC1, which is the providing apparatus (F401). Then, DSC2 and DSC3 wait for a protocol start message or a wait signal from DSC1 (F402, F403). It is assumed here that DSC2 first sends a protocol start request and then DSC3 sends a protocol start request as stated earlier.

Upon reception of a protocol start message (here DSC2 receives the protocol start message), DSC2 starts a configuration information notification protocol with DSC1 (F410). DSC2 then exchanges various messages with DSC1 using the configuration information notification protocol to receive wireless parameters from DSC1.

Upon reception of a wait signal (here DSC3 receives the wait signal), DSC3 refers to network information added to the wait signal to determine a network over which the configuration information notification protocol is to be executed with DSC1. DSC3 then compares the network information added to the wait signal with network information of the network in which DSC3 is currently participating (F404).

If the comparison shows that the two pieces of network information are the same, DSC3 determines that the configuration information notification protocol is to be executed on the network in which DSC3 is currently participating, and waits for a protocol start message from DSC1 (F409).

On the other hand, if the comparison shows that the two pieces of network information differ, DSC3 determines that the configuration information notification protocol is to be executed with DSC1 on a network specified by the network information added to the wait signal. DSC3 performs a process for finding the network that matches the network information added to the wait signal (F406 and F407). Finding methods include a method for finding information, and a method for sending a probe request including the network information and listening for a response to the probe request.

When DSC3 finds a network specified by the network information as a result of the finding, DSC3 joins the found network (F408) and waits for a protocol start message from DSC1 (F409).

Upon reception of the protocol start message, DSC3 starts the configuration information notification protocol with DSC1 (F410) and obtains wireless parameters.

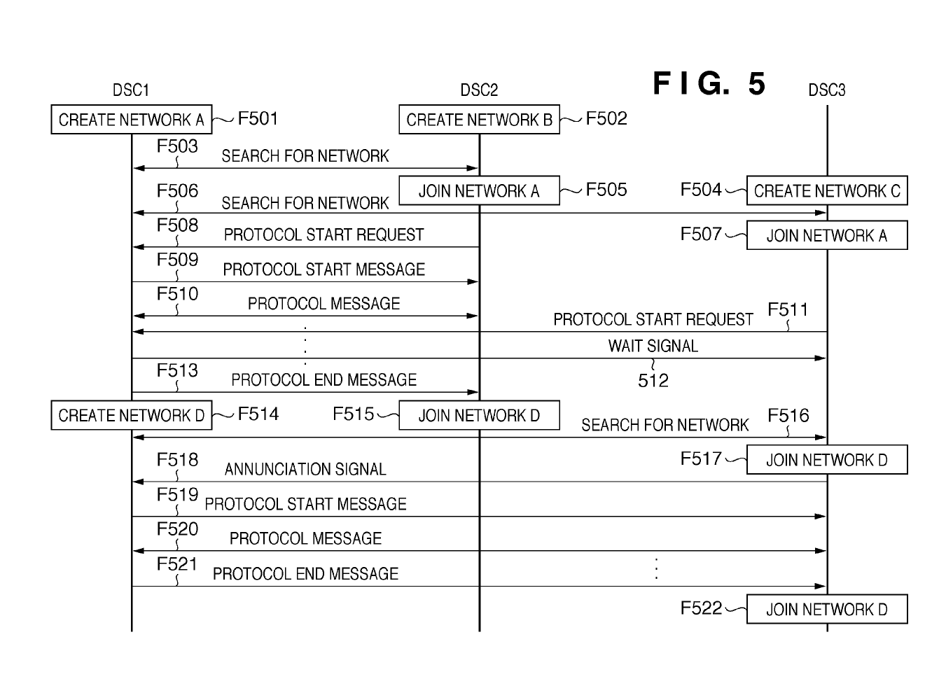

FIG. 5 shows a process sequence of DSC1, DSC2, and DSC3.

When the automatic wireless parameter configuration application is activated on DSC1 by a trigger such as a user action, DSC1 creates network A (F501). Similarly, when the automatic wireless parameter configuration application is activated on DSC2 by a trigger such as a user action, DSC2 creates network B (F502).

DSC1 and DSC2 perform a process for searching for a network and determine their roles in accordance with the role assignment algorithm described above (F503). Here DSC1 is assigned as the providing apparatus and DSC2 is assigned as a receiving apparatus. The receiving apparatus DSC2 joins network A in which DSC1 is participating (F505).

The networks created after activation of the automatic wireless parameter configuration application are networks for performing a wireless parameter configuration process and a common encryption key and a common authentication key are not set for DSC1 and DSC2. Therefore, DSC2 is not allowed to communicate with DSC1 on network A using signals other than predetermined signals (such as an annunciation signal and messages of the configuration information notification protocol) and cannot perform data communication that uses encryption and authentication.

When the automatic wireless parameter configuration application is activated on DSC3 by a trigger such as a user action, DSC3 creates network C (F504). DSC1 and DSC3 perform a process for searching for a network and determine their roles according to the role assignment algorithm described above (F506). Here, DSC1 continues to be the providing apparatus and DSC3 becomes a receiving apparatus. DSC3, which is a receiving apparatus, joins network A in which the providing apparatus DSC1 is participating (F507).

At this time point, DSC3 is not allowed to communicate with DSC1 using signals other than predetermined signals (such as an annunciation signal and messages of the configuration information notification protocol) and cannot perform data communication that uses encryption and authentication.

DSC2 assigned as a receiving apparatus sends a protocol start request to DSC1 in order to start the configuration information notification protocol (F508). Upon reception of the protocol start request from DSC2, DSC1 sends a protocol start message to DSC2 (F509).

Upon reception of the protocol start message, DSC2 starts exchanging protocol messages with DSC1 in accordance with the configuration information notification protocol (F510). Protocol messages are messages exchanged between a receiving apparatus and a providing apparatus. By exchanging protocol messages between the providing apparatus and the receiving apparatus, random numbers required for encryption and decryption and information required for mutual device authentication are exchanged and wireless parameters are provided.

DSC1 provides wireless parameters for network D to DSC2 using the configuration information notification protocol. That is, here the network on which the wireless parameter configuration process is performed differs from the network over which data communication is to be performed after the configuration.

DSC3 assigned as a receiving apparatus also sends a protocol start request to DSC1 in order to start the configuration information notification protocol (F511).

When DSC1 receives the protocol start request from DSC3 while executing the configuration information notification protocol with DSC2, DSC1 extracts network information of the network on which the configuration information notification protocol is to be executed with DSC3. Here, DSC1 executes the configuration information notification protocol with DSC2 to provide wireless parameters for network D to DSC2 in order to create network D after completion of the protocol. Therefore, DSC1 extracts network information of network D.

After extracting the network information of network D, DSC1 adds the network information to a wait signal and sends it to DSC3 (F512).

Upon reception of the wait signal, DSC3 refers to the network information added to determine the network on which the configuration information notification protocol is to be executed with DSC1. The added network information is information about network D, which differs from network A in which DSC3 is participating. Accordingly, DSC3 determines that the configuration information notification protocol is to be performed on network D, and periodically performs a process for searching for network D (F516) until network D is found.

After completion of the configuration information notification protocol with DSC2, DSC1 sends a protocol end message to DSC2 and creates new network D by using the wireless parameters provided to DSC2 (F514). The protocol end message is a message used by a providing apparatus to notify a receiving apparatus that execution of the configuration information notification protocol has ended.

When DSC2 receives the protocol end message, DSC2 joins network D by using the wireless parameters received from DSC1 using the configuration information notification protocol (F515). At this time point, DSC2 is allowed to perform data communication that uses encryption and authentication because an encryption key and an authentication key shared with DSC1 are set.

When DSC3 finds network D by the network search process (F516), DSC3 joins the found network D (F517).

At this time point, DSC3 is not allowed to communicate with DSC1 using signals other than predetermined signals (such as an annunciation signal and messages of the configuration information notification protocol) over network D and cannot perform ordinary data communication that uses encryption and authentication.

After joining network D, DSC3 sends an annunciation signal (F518). DSC1 and DSC2 also send an annunciation signal to each other, which is omitted from FIG. 5.

When DSC1 receives the annunciation signal sent from DSC3, DSC1 recognizes that DSC3 has joined network D, and sends a protocol start message to DSC3 (F519).

When DSC3 receives the protocol start message, DSC3 exchanges protocol messages with DSC1 in accordance with the configuration information notification protocol (F520). DSC1 provides wireless parameters for network D to DSC3 using the configuration information notification protocol. After the configuration information notification protocol with DSC3 ends, DSC1 sends a protocol end message to DSC3 (F521).

When DSC3 receives the protocol end message, DSC3 rejoins network D by using the wireless parameters received from DSC1 through the configuration information notification protocol (F522). At this time point, DSC3 is allowed to perform data communication that uses encryption and authentication because parameters such as an encryption key and authentication key shared with DSC1 and DSC2 are set.

As has been described above, according to the present exemplary embodiment, when the providing apparatus receives start requests to start a configuration information notification protocol from multiple receiving apparatuses, the providing apparatus can execute the configuration information notification protocol for the receiving apparatuses in sequence. Therefore, the present exemplary embodiment can prevent the wireless parameter configuration process from timing out and also can save a user the trouble of having to activating an automatic wireless parameter configuration application over and over, thereby improving usability for the user.

Furthermore, a receiving apparatus that sends a protocol start request while the providing apparatus is executing the configuration information notification protocol with another receiving apparatus does not need to resend the start request and only need to wait for a protocol start message sent from the providing apparatus.

When the providing apparatus switches to another network after executing the configuration information notification protocol with a receiving apparatus, the other receiving apparatus can identify the new network. Accordingly, the configuration information notification protocol can be executed on the new network.

### Second Embodiment

A second embodiment will be described. The system configuration and the block configuration of DSCs are the same as those in the first embodiment (FIGS. 1 and 2) and therefore description thereof will be omitted.

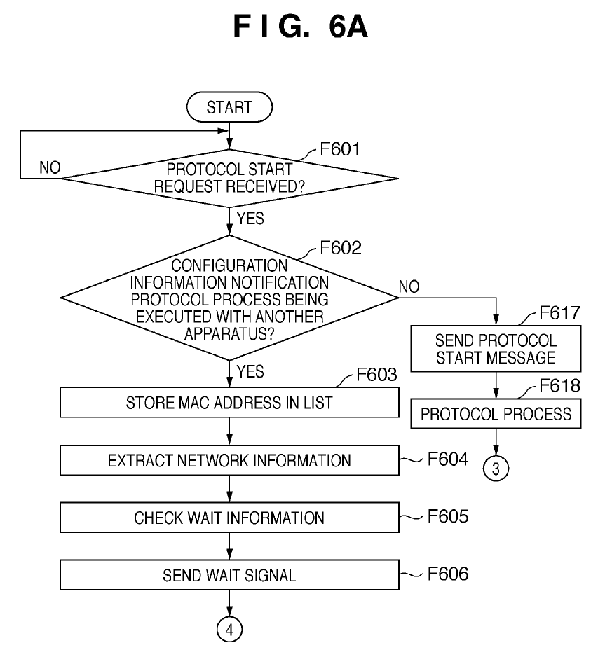

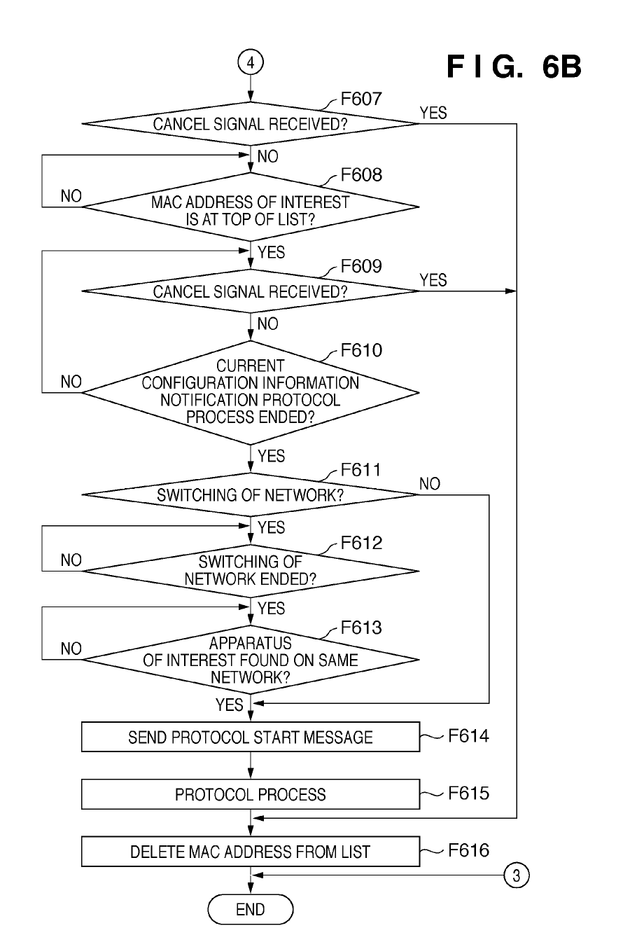

A process procedure performed by DSC1 acting as a providing apparatus will be described with reference to the flowcharts of FIGS. 6A and 6B. It is assumed in the description that DSC2 sends a protocol start request first and then DSC3 sends a protocol start request, as with the first embodiment.

DSC1 waits for a protocol start request sent from a receiving apparatus (F601). When DSC1 receives a protocol start request from DSC2, DSC1 determines whether a configuration information notification protocol is being executed with another receiving apparatus (F602).

If the configuration information notification protocol is not being executed with another receiving apparatus, DSC1 sends a protocol start message to DSC2 (F617).

After sending the protocol start message, DSC1 exchanges various messages with DSC2 using the configuration information notification protocol to provide wireless parameters to DSC2 (F618).

If the configuration information notification protocol is being executed with another receiving apparatus at F602 (if DSC1 receives a protocol start request from DSC3 while DSC1 is executing the configuration information notification protocol with DSC2 in this example), the process proceeds to F603. DSC1 stores the MAC (Media Access Control) address of DSC3 that sent the protocol start request after DSC2 in a storage unit 208 (F603). Here, the MAC address is stored in a list in the storage unit 208 in a FIFO (First-In First-Out) manner. After the configuration information notification protocol being executed with DSC2 ends, DSC1 extracts network information (an ESSID and a frequency channel) of a new network on which the configuration information notification protocol is to be executed and checks wait information (F605). Here, the wait information is information used by a receiving apparatus to determine the waiting time until the start of the configuration information notification protocol. The wait information may be the number of waiting receiving apparatuses, the processing time of the configuration information notification protocol, or the throughput of the providing apparatus, for example.

DSC1 adds the extracted network information and wait information to a wait signal and sends the signal to DSC3 (F606). Alternatively, DSC1, which is the providing apparatus, may calculate the waiting time and send it to DSC3 as wait information. DSC1 then waits until the MAC address of DSC3 moves to the top of the list in the storage unit 208 or DSC1 receives a cancel signal (F607, F608).

If DSC1 receives a cancel signal from DSC3, DSC1 deletes the MAC address of DSC3 from the list in the storage unit 208 (F616) and then ends the process.

When the MAC address of DSC3 moves to the top of the list in the storage unit 208, DSC1 waits until the configuration information notification protocol being executed with DSC2 ends or DSC1 receives a cancel signal (F609, F610).

When DSC1 receives a cancel signal from DSC3, DSC1 deletes the MAC address of DSC3 from the list in the storage unit 208 (F616) and then ends the process.

On the other hand, when the configuration information notification protocol being executed ends, the process proceeds to F611. The sequence from 1611 to F615 is the same as the sequence from F308 to F312 in FIG. 3B and therefore the description thereof will be omitted here.

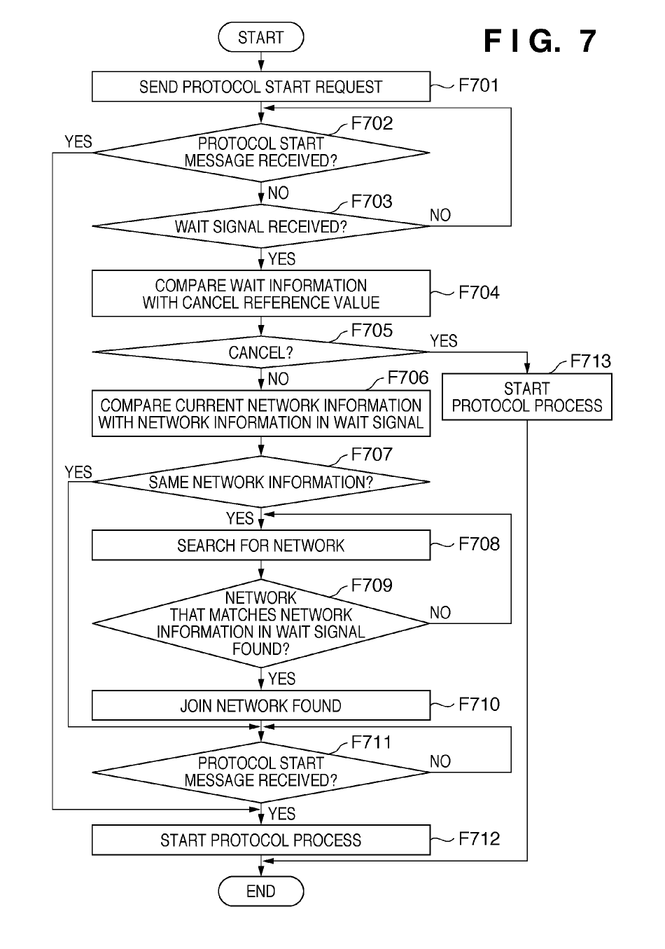

A process procedure performed by DSC2 and DSC3, which are receiving apparatuses, will be described with reference to the flowchart of FIG. 7. It is assumed here that DSC2 sends a protocol start request first and then DSC3 sends a protocol start request, as stated above.

The receiving apparatuses, DSC2 and DSC3, send a protocol start request to the providing apparatus, DSC1 (1701). Then, DSC2 and DSC3 wait for a protocol start message or a wait signal from DSC1 (F702, F703).

Upon reception of a protocol start message (DSC2 receives one here), DSC2 starts the configuration information notification protocol with DSC1 (F711). DSC2 then exchanges various messages with DSC1 using the configuration information notification protocol to receive wireless parameters from DSC1 (F712).

Upon reception of a wait signal (DSC3 receives one here), DSC3 refers to the wait information added to the wait signal and compares the wait information with a cancel reference value (F704). The cancel reference value is a predetermined reference value to determine whether the receiving apparatus should cancel a wireless parameter configuration process and may be the upper limit of waiting time. The cancel reference value may be preset on the apparatuses or may be set by a user.

If the wireless parameter configuration process is to be canceled (for example if DSC3 determines that the waiting time exceeds the upper limit of waiting time that is the cancel reference value), DSC3 sends a cancel signal to DSC1 (F713). If the wireless parameter configuration process is not to be canceled, the process proceeds to F706.

The sequence from F706 to F712 is the same as the sequence from F404 to F410 of FIG. 4 and therefore the description thereof will be omitted here. At F711, DSC3 may refer to the waiting time determined based on the wait information to enter an electric power saving mode and remain in the mode until DSC3 receives a protocol start message from DSC1.

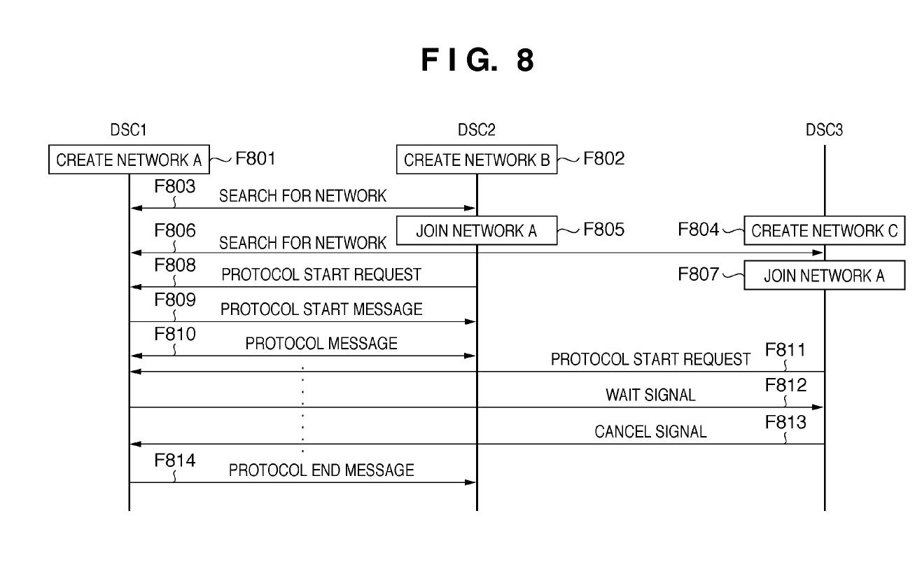

FIG. 8 shows a process sequence of DSC1, DSC2, and DSC3. The sequence from F801 to F811 is the same as the sequence from F501 to F511 of FIG. 5 and therefore the description thereof will be omitted here.

When DSC1 receives a protocol start request (F811) from DSC3 while executing the configuration information notification protocol with DSC2, DSC1 extracts network information of the network on which the configuration information notification protocol is to be executed with DSC3 and the wait information described above. In this case, DSC1 provides wireless parameters for network A to DSC2 using the configuration information notification protocol with DSC2 and, after the end of the protocol, performs data communication with DSC2 over network A. Therefore, DSC1 extracts network information of network A.

DSC1 adds the extracted network information and wait information to a wait signal and sends the wait signal to DSC3 (F812). Upon reception of the wait signal, DSC3 compares the wait information added and the cancel reference value that DSC3 holds. It is assumed here that the value of the wait information exceeds the cancel reference value. As a result, DSC3 sends a cancel signal to DSC1 (F813).

When DSC1 receives the cancel signal, DSC1 deletes the MAC address of DSC3 from the list in the storage unit 208 and cancels the wireless parameter configuration process to be performed with DSC3.

Upon completion of the configuration information notification protocol with DSC2, DSC1 sends a protocol end message to DSC2 (F814). When DSC2 receives the protocol end message, DSC2 uses the wireless parameters obtained using the configuration information notification protocol to rejoin network A. At this time, DSC2 is allowed to perform data communication that uses encryption and authentication because parameters such as an encryption key and authentication key shared with DSC1 are set.

The present exemplary embodiment has, in addition to the effects of the first embodiment, the effect of enabling a receiving apparatus to cancel on its own a configuration information notification protocol process when the receiving apparatus will have to wait for a long time until the configuration information notification protocol starts.

While the preferred embodiments of the present invention have been described above, the embodiments are illustrative of the present invention only and various modifications can be made to the exemplary embodiments without departing from the spirit of the present invention.

While an ESSID and a frequency channel are used as network information in the exemplary embodiments described above, not both of the ESSID and the frequency channel are required but either of them may be used.

In the foregoing description, a receiving apparatus determines the waiting time until the start of the wireless parameter configuration process on the basis of wait information and makes determination as to whether the receiving apparatus should cancel the wireless parameter configuration process. However, the determination as to whether to cancel the process may be based on other reference. For example, the determination may be made based on the number of waiting apparatuses. In this case, the upper limit of the number of waiting apparatuses may be predetermined as the cancel reference value on the receiving apparatus and the receiving apparatus may determine whether to cancel the process on the basis of whether the number of waiting apparatuses, which is sent from the providing apparatus as wait information, exceeds the cancel reference value.

While the present invention has been described with respect to IEEE 802.11-compliant wireless LANs by way of example, the present invention is applicable to wireless communication networks of other types as well, such as wireless USB, Bluetooth (registered trademark), and UWB (Ultra Wide Band) networks. The present invention is also applicable to wired communication such as wired LANs.

It will be understood that the object of the present invention can also be achieved by providing a recording medium on which a program code that implements the functions of any of the exemplary embodiments described above is recorded to a system or an apparatus to allow the computer (CPU or MPU) of the system or apparatus to read and execute the program code recorded on the recording medium.

In this case, the program code read from the recording medium implements the functions of any of the exemplary embodiments described above and the recording medium on which the program code is recorded constitutes the present invention.

The recording medium for providing the program code may be a floppy (registered trademark) disk, hard disk, optical disk, magneto-optical disk, CD-ROM, CD-R, magnetic tape, non-volatile memory card, or ROM.

The functions of any of the exemplary embodiments can be implemented not only by causing a computer to read and execute the program code. The present invention also includes an implementation in which an operations system (OS) running on a computer performs part or all of actual processing in accordance with instructions in the program code and the processing implements the function of any of the exemplary embodiments described above, of course.

The present invention also includes an implementation in which the program code read from a recording medium is written on a memory provided in a function expansion card inserted in a computer or a function expansion unit connected to a computer, then a CPU and other components provided in the function expansion card or the function expansion unit perform part or all of actual processing in accordance with instructions in the program code and the processing implements the functions of any of the exemplary embodiments described above.

As has been described above, a communication apparatus that performs a communication parameter configuration process executes a communication parameter configuration process with a first communication apparatus. The communication apparatus detects a start request to start a communication parameter configuration process from a second communication apparatus while the communication apparatus is executing the communication parameter configuration process with the first communication apparatus. When the communication apparatus detects the start request to start the communication parameter configuration process, the communication apparatus sends to the second communication apparatus network information of the network in which the communication apparatus participates after the communication parameter configuration process with the first communication apparatus ends. Accordingly, when the communication apparatus switches to the other network after the communication parameter configuration process with the first communication apparatus ends, the second communication apparatus can identify the new network in which the communication apparatus is participating.

Furthermore, the network in which the communication apparatus participates after the communication parameter configuration process with the first communication apparatus ends is the network over which the communication apparatus is to perform a communication parameter configuration process with the second communication apparatus. Thus, the second communication apparatus can configure communication parameters with the communication apparatus without a user having to perform a special operation on the second communication apparatus.

Furthermore, the communication apparatus notifies the second communication apparatus of the start of the communication parameter configuration process after the communication parameter configuration process with the first communication apparatus ends. Accordingly, the communication apparatus can proceeds to the communication parameter configuration process with the second communication apparatus without interruption after the communication parameters for communication with the first communication apparatus are configured.

The communication apparatus also sends information for determining waiting time until the start of the communication parameter configuration process to be performed with the second communication apparatus. Based on the information, the second communication apparatus can determine whether to cancel the communication parameter configuration process.

The network information includes a network identifier or a frequency channel.

The communication apparatus that performs the communication parameter configuration process requests another communication apparatus to start a communication parameter configuration process and receives a signal including network information as a response to the request. Based on the network information included in the signal received, the communication apparatus identifies a network over which the communication apparatus is notified by another communication apparatus of the start of the communication parameter configuration process. Therefore, even if the requesting communication apparatus is executing the communication parameter configuration process with another apparatus when the requesting apparatus requests the start of the communication parameter configuration process, the requesting communication apparatus can identify the network on which the communication parameter configuration process is to be performed after the completion of the preceding communication parameter configuration process.

If the network information included in the signal received differs from network information of the network in which the communication apparatus is participating, the communication apparatus joins a network determined by the network information included in the signal. Then, the communication apparatus waits for a notification of the start of the communication parameter configuration process on the network the communication apparatus has just joined. Thus, the communication apparatus can wait until the start of the communication parameter configuration process on the network the apparatus has joined.

The received signal includes information for determining waiting time until the start of the communication parameter configuration process. Based on the information, the communication apparatus determines whether to cancel the communication parameter configuration process. Thus, flexible control can be achieved as to whether to proceed to or cancel the communication parameter configuration process in accordance with waiting time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-230408, filed on Sep. 5, 2007, which is hereby incorporated by reference herein in its entirety.

1. A control method for controlling a communication apparatus that performs a communication parameter configuration process, comprising:
performing a communication parameter configuration process between said communication apparatus and a first communication apparatus;
detecting a start request to start communication parameter configuration process sent from a second communication apparatus while the communication parameter configuration process is being performed between said communication apparatus and said first communication apparatus; and
sending, to said second communication apparatus, network information of a network in which said communication apparatus participates after the end of the communication parameter configuration process between said communication apparatus and said first communication apparatus, when the start request is detected in said detecting step.

2. The control method according to claim 1, wherein the network information sent after the end of the communication parameter configuration process between said communication apparatus and said first communication apparatus is network information of a network over which communication parameter configuration process is to be performed between said communication apparatus and said second communication apparatus.

3. The control method according to claim 1, wherein the network information sent after the end of the communication parameter configuration process between said communication apparatus and said first communication apparatus is network information of a network formed by using the communication parameter provided by said communication apparatus to said first communication apparatus.

4. The control method according to claim 1, wherein after the end of the communication parameter configuration process between said communication apparatus and said first communication apparatus, said second communication apparatus is notified of the start of communication parameter configuration process.

5. The control method according to claim 1, wherein in said sending step, information is sent for determining waiting time until the start of communication parameter configuration process between said communication apparatus and said second communication apparatus.

6. The control method according to claim 1, wherein the network information includes at least one of a network identifier and a frequency channel.

7. A control method for controlling a communication apparatus that performs a communication parameter configuration process, comprising:
requesting another communication apparatus to start a communication parameter configuration process;
receiving a signal including network information in response to the request; and
determining a network over which the start of the communication parameter configuration process is notified from said another communication apparatus on the basis of the network information included in the signal received in said receiving step.

8. The control method according to claim 7, wherein:
if the network information included in the signal received in said receiving step differs from the network information of a network in which said communication apparatus participates, said communication apparatus joins a network determined by the network information included in the signal; and
said communication apparatus waits for a notification of the start of the communication parameter configuration process on the network that said communication apparatus has joined.

9. The control method according to claim 7, wherein:
the signal received in said receiving step includes information for determining waiting time until the start of the communication parameter configuration process; and
determination is made, on the basis of the information, as to whether the communication parameter configuration process should be cancelled.

10. A communication apparatus capable of executing the control method according to claim 1.

11. A computer-readable storage medium storing a computer program for causing a computer to execute the control method according to claim 1.
